(19) United States
(12) Patent Application Publication
(10) Pub. No.: US 2019/0009452 A1
(43) Pub. Date: Jan. 10, 2019

(54) MOLD PLATEN WITH WOVEN SURFACE TEXTURE AND THERMOSET ARTICLE MADE THEREFROM

(71) Applicant: Continental Structural Plastics, Inc., Aubum Hills, MI (US)

(72) Inventors: Frank MACHER, Auburn Hills, MI (US); August LANDENSACK, Auburn Hills, MI (US); Donald BROWN, Auburn Hills, MI (US)

(21) Appl. No.: 16/068,454

(22) PCT Filed: Jan. 24, 2017
(86) PCT No.: PCT/US2017/014747

§ 371 Date: Jul. 6, 2018

Related U.S. Application Data
(60) Provisional application No. 62/287,346, filed on Jan. 26, 2016.

(51) Int. Cl. B29C 59/06; B29C 51/22

(52) U.S. Cl. CPC B29C 59/06; B29C 70/48; B29C 51/225

(57) ABSTRACT

A method for imparting textures of grained or woven patterns to the surfaces of thermoset articles during the formation of the article includes a platen with a texture being introduced into a mold. A thermoset material is charged into the mold. Pressure and heat are applied to bring the thermoset material into contact with the platen to impart the texture to a surface of the thermoset material. The thermoset material is allowed to cure in the mold. The thermoset article is removed from the mold with the texture. The textured article is structurally improved relative to a like article formed with a smooth or other platen texture. A system for producing the article by way of the method is also provided.

### RELATED APPLICATIONS

This application claims priority benefit of U.S. Provisional Application Ser. No. 62/287,346 filed 26 Jan. 2016; the contents of which are hereby incorporated by reference.

### FIELD OF THE INVENTION

The present invention in general relates to thermoset manufacturing and in particular to mold platens with surface textures for imparting textures to the surfaces of thermoset articles made therefrom.

### BACKGROUND OF THE INVENTION

Thermoset materials are materials that are made by polymers joined together by chemical bonds that form a highly crosslinked polymer structure. The highly crosslinked structure produced by the chemical bonds in thermoset materials, is directly responsible for the high mechanical and physical strength of thermoset materials as compared with thermoplastics or elastomers materials. A characteristic parameter of thermoset materials are their gel point, which refers to the time when the material changes in an irreversible way from a viscous liquid resin state to a solid state during the curing process. Once a thermoset material has been transferred through the gel point the material stops flowing and can no longer be molded.

Resin transfer molding (RTM) is a method of fabricating composite structures with high strength, complex geometries, tight dimensional tolerances, and part quality typically required for automotive and aerospace applications. RTM uses a closed mold commonly made of aluminum with a fiber “lay-up” such as graphite placed into the mold. The mold is closed, sealed, heated, and placed under vacuum. A room temperature (20° C.) or heated resin is then injected into the mold to impregnate the fiber layup. Having the mold heated and under vacuum assists the resin flow. The mold is then held at a temperature sufficient to cure the resin. Typically, a resin experiences three distinct states during the RTM process; a viscous state during injection, a jelling state during which the viscosity of the resin changes to a higher viscosity, and a cure time when the resin materials chemically crosslink and the resin hardens. Molds used for RTM have one or more injection ports for introducing the resin, and at least one exhaust port for gas and excess resin to leave the mold. Multiport injection molds are typically used for larger parts that have an increased processing time.

Sheet molding compound (SMC) is a ready to mold fiber reinforced polyester material primarily used in compression molding. The sheet is provided in rolls. SMC is both a process and reinforced composite material. SMC is manufactured by dispersing long strands (usually >1″) of chopped fiber (commonly glass fibers or carbon fibers on a bath of resin (commonly polyester resin, vinylester resin or epoxy resin). During SMC manufacturing a paste reservoir dispenses a measured amount of specified resin paste onto a plastic carrier film. This carrier film passes underneath a chopper which cuts the fibers onto the surface. Once the chopped fibers have drifted through the depth of resin paste, another sheet is added on top which sandwiches the glass. The sheets are compacted and then enter onto a take-up roll, which is used to store the product while it matures. The carrier film is then later removed and the material is cut into charges. Depending on what final product shape is required determines the shape of the charge and a steel die which the SMC is then added to. Heat and pressure act on the charge and once fully cured, this is then removed from the mold as the finished product. The longer fibers (LF) in SMC result in better strength properties than standard bulk molding compound (BMC) products. Typical applications include demanding electrical applications, corrosion resistant needs, structural components at low cost, automotive, and transit.

While the use of resin transfer molding and sheet molding compounds have gained widespread use in automotive and aerospace applications as an alternative to metal body components there still are surface unevenness and finish related issues, especially with carbon fiber impregnated SMC (CF-SMC). Thus, there exists a need to mask surface unevenness and finish related issues of molded composite materials.

### SUMMARY OF THE INVENTION

A method for imparting textures of grained or woven patterns to the surfaces of thermoset articles during the formation of the article includes a platen with a texture being introduced into a mold. A thermoset material is charged into the mold. Pressure and heat are applied to bring the thermoset material into contact with the platen to impart the texture to a surface of the thermoset material. The thermoset material is allowed to cure in the mold. The thermoset article is removed from the mold with the texture. The textured article is structurally improved relative to a like article formed with a smooth or other platen texture. A system for producing the article by way of the method is also provided.

### BRIEF DESCRIPTION OF THE DRAWINGS

FIG. 1 is a top down view of the face of a platen showing a patterned surface for making a surface impression on a die material in a mold in accordance with an embodiment of the invention;

FIG. 2 is a side view of a system for forming parts from sheet molding composition thermoset materials in a mold with a patterned platen of FIG. 1 in accordance with an embodiment of the invention; and

FIGS. 3A-3C are a series of views of molded textured parts formed with a patterned platen surface according to embodiments of the invention;

### DETAILED DESCRIPTION OF THE INVENTION

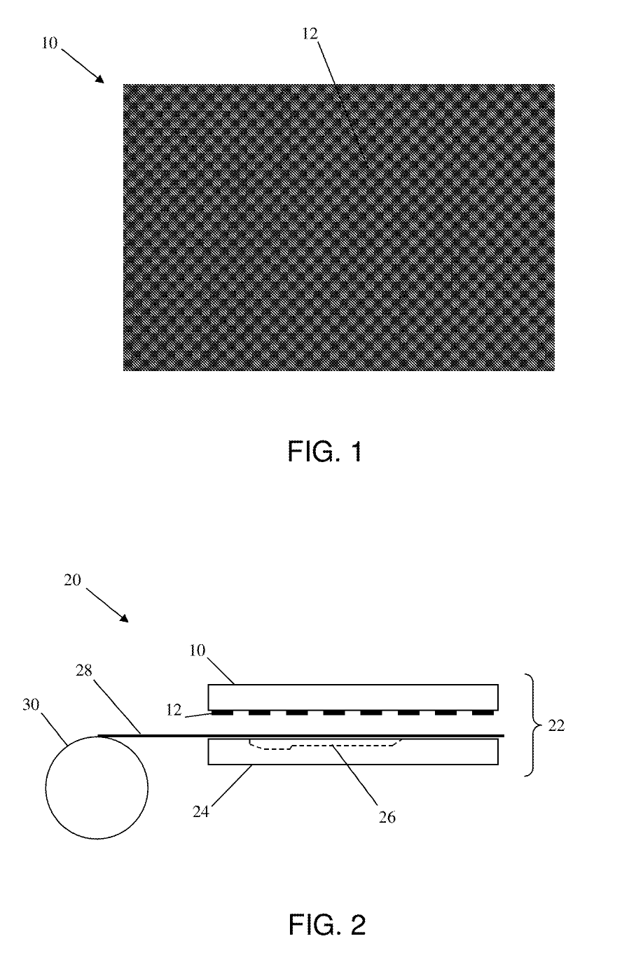

The present invention has utility as a system and method for imparting textures to the surfaces of thermoset articles during the articles formation with a patterned mold platen. In a specific inventive embodiment a mold platen is provided with a woven surface texture. In a specific inventive embodiment a grained mold is provided that produces a “carbon fiber fabric grain” when a carbon fiber SMC (CF-SMC) material is used to form an article so that surface of the article appears to be a carbon fiber fabric. This texture includes weaves and wefts with each region itself composed of parallel score lines that mimics a woven carbon fiber mat molded in thermoset resin. The resultant carbon fiber fabric grain covers for the “ugly loo” seen on the surface of a CF-SMC panel, and hides the bumpy surface of CF-SMC so that the formed article appearance has an acceptable visual appearance for visually sensitive applications such as exposed automotive part applications illustratively including decklid inners and other exposed surface panels. The textured platen tool “molds in” the exposed weave of the carbon fiber grain an example of which is shown in FIG. 1. FIG. 1 is a top down view of the face 12 of a platen 10 showing a patterned surface for making a surface impression on a die material in a mold.

FIG. 2 is a side view of a system 20 for forming parts from sheet molding composition (SMC) thermoset materials 28 in a mold 22 with a platen 10 with a pattern 12 of FIG. 1. The SMC 28 may be supplied to the mold 22 from a roll 30. The lower portion of the mold 22 is a base 24 that may have a series of depressions or cavities 26 to provide a shape to the molded article. The mold 22 may be positioned in a chamber with a controlled atmosphere for parameters illustratively including pressure and temperature.

While the textured platen is shown in a mold for SMC, the textured platen may also be used in injection molding illustratively including for thermosets in resin transfer molding (RTM). Resins used in the RTM process may include thermosetting resins such as epoxy; urethanes; polyesters, and vinylesters; that are low in viscosity and easy to be impregnated into reinforcing fibers. These resins illustratively include epoxy resin, an unsaturated polyester resin, a polyvinylester resin, a phenolic resin, a polyimide resin such as bismaleimide triazine resin, a furan resin, a polyurethane resin, a polydiarylphthalate resin, a melamine resin, a urea resin, an amino resin, etc. Fibers may be introduced to the resin used in certain embodiments of the inventive channel resin feed RTM process to strengthen formed parts including glass, carbon, and other synthetic fibers, as well as natural fibers. Natural fibers may include coconut fibers, bamboo fibers, sugar cane fibers, banana skin fibers, etc. The added fibers being chopped fibers that are theoretically randomly oriented

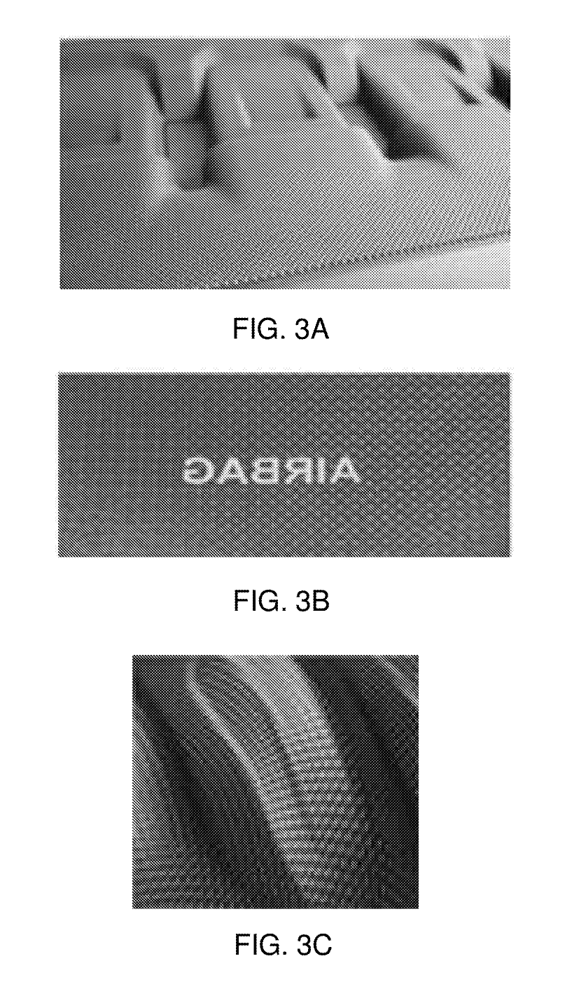

FIGS. 3A-3C are a series of views of molded textured parts formed with a patterned platen surface according to embodiments of the invention

The textured or woven pattern of the platen in inventive embodiments may be introduced to an existing paten tool as an insert thereby avoiding the need for expensive retooling for the use of differing patterns illustratively including different stipple grains and a sport-trac hex grain. In a specific embodiment a laser may be used to etch in the pattern on the platen surface.

In addition to the appearance benefits imparted by the textured platen to a formed article, additional benefits also include improved mechanical properties and additional surface area that can increase (paint) coating area and adhesion properties, compared to other patterns or smooth surfaces. The texture article surface also provides the surprising result of improving the aerodynamic properties of the article. For example dimples may be added to an article surface.

The foregoing description is illustrative of particular embodiments of the invention, but is not meant to be a limitation upon the practice thereof. The following claims, including all equivalents thereof, are intended to define the scope of the invention.

1. A method for imparting textures to the surfaces of thermoset articles during the articles formation comprising;
introducing a platen with a texture grained or woven patterns to a mold;
providing a thermoset material to the mold;
applying the platen under pressure and heat to the thermoset material to impart the texture to a surface of the thermoset material;
allowing the thermoset material to cure; and
removing the thermoset article from the mold.

2. The method of claim 1 wherein the platen is provided with a woven surface texture.

3. The method of claim 1 wherein the platen is provided with a grained pattern.

4. The method of claim 1 wherein the platen is laser etched to provide the texture.

5. The method of claim 1 wherein the thermoset material is a resin of at least one of an epoxy resin, an unsaturated polyester resin, a polyvinylester resin, a phenolic resin, a guanamine resin, a polyimide resin, a bismaleimide triazine resin, a furan resin, a polyurethane resin, a polydiarylphthalate resin, a melamine resin, a urea resin, or an amino resin.

6. The method of claim 1 wherein the resin further comprises fibers.

7. The method of claim 6 wherein the fibers are at least one of glass, carbon, or other synthetic fibers.

8. The method of claim 6 wherein the fibers are natural fibers.

9. (canceled)

10. The method of claim 1 wherein the fibers are chopped fibers.

11. The method of claim 1 wherein the thermoset material is a sheet molding composition (SMC).

12. The method of claim 1 wherein the thermoset material is impregnated with carbon fibers.

13. A system for producing textured surfaces on a thermoset article, the system comprising:
a platen with a texture of grained or woven patterns; and
a mold base, said mold base adapted to receive a supply of a thermoset material.

14. The system of claim 13 wherein the platen has a woven surface texture.

15. The system of claim 13 wherein the platen has a grained pattern.

16. The system of claim 13 wherein the platen is laser etched to provide the texture.

17-22. (canceled)

23. The system of claim 13 wherein the thermoset material is a sheet molding composition (SMC).

24. The system of claim 13 wherein the thermoset material is impregnated with carbon fibers.

25. An article produced by the method of claim 1.
